(19) United States
(12) Patent Application Publication
(10) Pub. No.: US 2024/0428599 A1
(43) Pub. Date: Dec. 26, 2024

(54) ADAPTIVE CAMERA MISALIGNMENT CORRECTION AND ROAD GEOMETRY COMPENSATION FOR LANE DETECTION

(71) Applicant: Atieva, Inc., Newark, CA (US)

(72) Inventors: Haoyu Sun, Sunnyvale, CA (US); Bo Ji, Fremont, CA (US)

(21) Appl. No.: 18/705,151

(22) PCT Filed: Oct. 28, 2022
(86) PCT No.: PCT/US2022/078926

§ 371 Date: Apr. 26, 2024

Related U.S. Application Data
(60) Provisional application No. 63/263,292, filed on Oct. 29, 2021.

(51) Int. Cl. G06V 20/56; G06T 7/62

(52) U.S. Cl. CPC G06V 20/588; G06T 7/62; G06T 2207/30256

(57) ABSTRACT

A method may capture images of the vehicle lane using a camera attached to a moving vehicle. The method may determine, based on the captured one or more images, locations of a plurality of first lane markings defining a left extent of a lane and a plurality of second lane markings defining a right extent of the lane. The method may project the determined locations in the one or more images to locations in a coordinate system of the roadway. The method may determine a plurality of widths of the lane in the coordinate system of the roadway over a range of distances. The method may determine variations of the lane widths in the coordinate system of the roadway over the range of distances. The method may rescale the lane widths over the range of distances in the coordinate system to reduce determined variations of the lane widths.

### CROSS-REFERENCE TO RELATED APPLICATION

This application claims priority to U.S. Provisional Patent Application No. 63/263,292, filed on Oct. 29, 2021, and entitled “ADAPTIVE CAMERA MISALIGNMENT CORRECTION AND ROAD GEOMETRY COMPENSATION FOR LANE DETECTION,” the disclosure of which is incorporated by reference herein in its entirety.

### TECHNICAL FIELD

This disclosure relates to optical sensing of objects outside a vehicle and, in particular, to techniques for correction of adaptive camera misalignment and road geometry compensation for lane detection.

### BACKGROUND

Some vehicles manufactured nowadays are equipped with one or more types of systems that can sense objects outside the vehicle and that can handle, at least in part, operations relating to the driving of the vehicle. Some such assistance involves automatically surveying surroundings of the vehicle and being able to take action regarding detected vehicles, pedestrians, or objects. When the surveillance is performed during travel, a faster response time from the system is generally preferred as it may increase the amount of time available to take remedial action after detection.

### SUMMARY

In some aspects, the techniques described herein relate to a method of determining a width of a vehicle lane on a roadway from imaged lane markings. The method includes capturing one or more images of the vehicle lane using a camera attached to a moving vehicle, and determining, based on the captured one or more images, locations of a plurality of first lane markings defining a left extent of a lane and a plurality of second lane markings defining a right extent of the lane. The determined locations in the one or more images are projected to locations in a coordinate system of the roadway, and a plurality of widths of the lane in the coordinate system of the roadway are determined over a range of distances. Variations of the lane widths in the coordinate system of the roadway are determined over the range of distances, and the lane widths are rescaled over the range of distances in the coordinate system to reduce determined variations of the lane widths.

In some aspects, the techniques described herein relate to a vehicle, the vehicle including: a camera configured for capturing one or more images of a vehicle lane of a roadway while the vehicle is moving on the roadway; and one or more processors configured for executing machine-readable instructions, stored on a memory, to cause the one or more processors to: determine, based on the captured one or more images, locations of a plurality of first lane markings defining a left extent of the vehicle lane and a plurality of second lane markings defining a right extent of the vehicle lane; project the determined locations in the one or more images to locations in a coordinate system of the roadway; determine a plurality of widths of the lane in the coordinate system of the roadway over a range of distances; determine variations of the lane widths in the coordinate system of the roadway over the range of distances; and rescale the lane widths over the range of distances in the coordinate system to reduce determined variations of the lane widths.

Implementations can include one or more of the following features, alone or in any combination with each other.

For example, the rescaled lane widths and coordinates of lane markings in the coordinate system of the roadway, which are associated with the rescaled lane widths, can be stored in a memory.

For example, rescaling the lane widths to reduce a sum of the variations can include minimizing a cost function associated with a variation of the lane widths over the range of distances, wherein minimizing the cost function includes modeling a divergence/convergence of the lane width as a function of distance from the vehicle and determining one more parameters used to rescale the lane widths over the range of distances, such that the parameters minimize the cost function.

For example, for a plurality of fixed distances from the vehicle, ratios of successive determined lane widths can be determined, and a sum of the ratios can be determined, and rescaling the lane widths over the range of distances in the coordinate system can reduce determined the determined sum.

For example, the determined locations of a plurality of first lane markings defining a left extent of a lane and a plurality of second lane markings defining a right extent of the lane can be fit to a polynomial curve, and the locations of the first and second lane markings can be based on the fitted curve.

For example, the lane widths for the range of distances can be determined based on transverse distances between locations of the first and second lane markings at similar distances from the vehicle.

### BRIEF DESCRIPTION OF DRAWINGS

FIG. 1 shows an example of a vehicle.

FIG. 2 is a schematic diagram of a roadway coordinate system used for navigating a roadway and a camera coordinate system within which images are captured to be used for one or more assisted-driving functions within the vehicle.

FIG. 3A, FIG. 4A, and FIG. 5A show example images of a scene captured by the camera when the camera has different pitch angles with respect to the roadway.

FIG. 3B, FIG. 4B, and FIG. 5B show example projections, respectively, of the lane markings of FIG. 3A, FIG. 4A, and FIG. 5A to a roadway coordinate system having an origin on the roadway at a location between the front wheels of the vehicle.

FIG. 6A, FIG. 7A, and FIG. 8A show example images of a scene captured by the camera when the camera has different roll angles with respect to the roadway.

FIG. 6B, FIG. 7B, and FIG. 8B show example projections, respectively, of the lane markings of FIG. 6A, FIG. 7A, and FIG. 8A to a roadway coordinate system having an origin on the roadway at a location between the front wheels of the vehicle.

FIG. 9 is a flowchart of an example process for determining a width of a vehicle lane on a roadway from imaged lane markings.

FIG. 10 illustrates an example architecture of a computing device that can be used to implement aspects of the present disclosure, including any of the systems, apparatuses, and/or techniques described herein, or any other systems, apparatuses, and/or techniques that may be utilized in the various possible embodiments.

### DETAILED DESCRIPTION

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle. Vehicles in the present examples are illustrated as being similar or identical to each other for illustrative purposes only.

As used herein, the terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

Examples herein refer to a vehicle body. A vehicle body is the main supporting structure of a vehicle to which components and subcomponents are attached. In vehicles having unibody construction, the vehicle body and the vehicle chassis are integrated into each other. As used herein, a vehicle chassis is described as supporting the vehicle body also when the vehicle body is an integral part of the vehicle chassis. The vehicle body often includes a passenger compartment with room for one or more occupants; one or more trunks or other storage compartments for cargo; and various panels and other closures providing protective and/or decorative cover.

Examples herein refer to assisted driving. In some implementations, assisted driving can be performed by an assisted-driving (AD) system, including, but not limited to, an autonomous-driving system. For example, an AD system can include an advanced driving-assistance system (ADAS). Assisted driving involves at least partially automating one or more dynamic driving tasks. An ADAS can perform assisted driving and is an example of an assisted-driving system. Assisted driving is performed based in part on the output of one or more sensors typically positioned on, under, or within the vehicle. An AD system can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking.

While an autonomous vehicle is an example of a system that performs assisted driving, not every assisted-driving system is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

Examples herein refer to a sensor. A sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., LiDAR); a radio-based sensor (e.g., radar); an acoustic sensor (e.g., an ultrasonic device and/or a microphone); an inertial measurement unit (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); an inertial measurement unit; a torque sensor; a temperature sensor (e.g., a primary or secondary thermometer); a pressure sensor (e.g., for ambient air or a component of the vehicle); a humidity sensor (e.g., a rain detector); or a seat occupancy sensor.

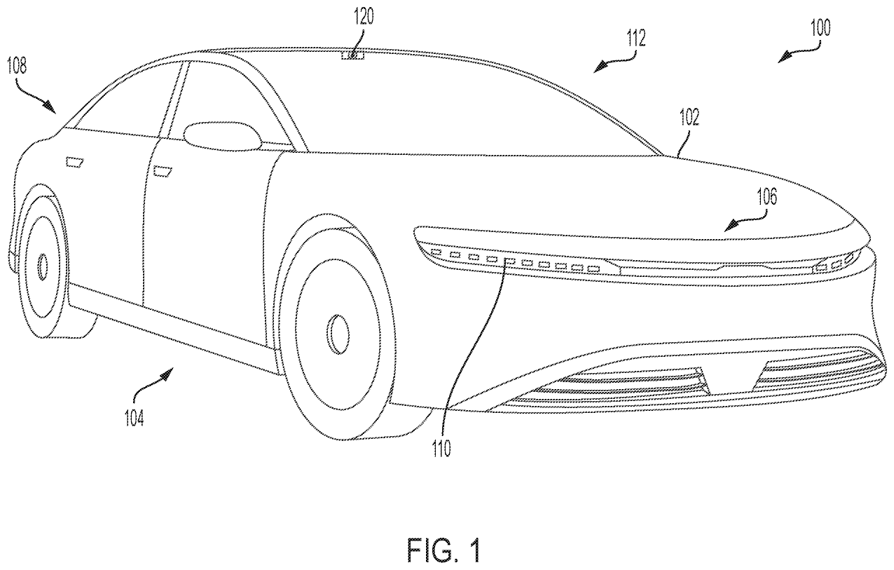

FIG. 1 shows an example of a vehicle 100. The vehicle 100 can be used with one or more other examples described elsewhere herein. The vehicle 100 includes a vehicle body 102 and a vehicle chassis 104 supporting the vehicle body 102. For example, the vehicle body 102 is here of a four-door type with room for at least four occupants, and the vehicle chassis 104 has four wheels. Other numbers of doors, types of vehicle body 102, and/or kinds of vehicle chassis 104 can be used in some implementations.

The vehicle body 102 has a front 106 and a rear 108 and can have a passenger cabin 112 between the front and the rear. The vehicle 100 can have at least one motor, which can be positioned in one or more locations of the vehicle 100. In some implementations, the motor(s) can be mounted generally near the front 106, generally near the rear 108, or both. A battery module can be supported by chassis 104, for example, below the passenger cabin and can be used to power the motor(s). The vehicle 100 can have at least one lighting component, which can be situated in one or more locations of the vehicle 100. For example, the vehicle 100 can have one or more headlights 110 mounted generally near the front 106.

The rear 108 of the vehicle 100 can include a trunk compartment, and the front 106 of the vehicle 100 can include a front trunk (a.k.a., frunk) compartment, each of which is outside the passenger cabin and each of which can be used for storage of vehicle components or personal equipment.

The vehicle can include at least one camera 120. In some implementations, the camera 120 can include any image sensor whose signal(s) the vehicle 100 processes to perform one or more AD functions. For example, the camera 120 can be oriented in forward-facing direction relative to the vehicle (i.e., facing toward the front 106 of the vehicle 100) and can capture images of scenes in front of the vehicle, where the captured images can be used for detecting vehicles, lanes, lane markings, curbs, and/or road signage. The camera 120 can detect the surroundings of the vehicle 100 by visually registering a circumstance in relation to the vehicle 100.

The vehicle 100 can include one or more processors (not shown) that can process images captured by the camera 120, for example, using one or more machine vision algorithms or techniques, to perform various tasks related to one or more driving functions. For example, captured images can be processed to detect lane markings on a roadway upon which the vehicle is moving.

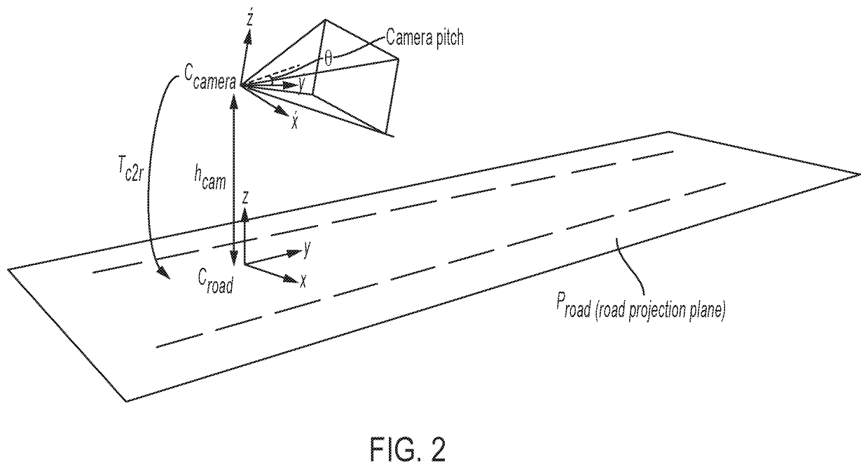

FIG. 2 is a schematic diagram of a roadway coordinate system used for navigating a roadway and a camera coordinate system within which images are captured to be used for one or more AD functions within the vehicle. As shown in FIG. 2, the roadway coordinate system C_{road}, can be defined by orthogonal vectors, x, y, z, and can have an origin on a roadway that moves with the vehicle. For example, the origin can be located on the roadway beneath the vehicle and midway between the front wheels of the vehicle. The z-direction can be in a vertical direction, normal to the plane of the roadway. The y-direction can be in a longitudinal direction, i.e., in a direction of travel along the roadway. The x-direction can be perpendicular to the Z-direction and to the Y-direction, and thus in a transverse direction, i.e., in the plane of the roadway, perpendicular to the direction of travel along the roadway. The camera coordinate system, C_{camera}, can be defined by orthogonal vectors, \hat{x}, ŷ, \hat{z}, and can have an origin at the location of the camera, which is located at a distance h_{cam} above the roadway. The \hat{x}, ŷ, \hat{z} directions need not be parallel to the respective x, y, z directions. In fact, the camera is generally angled, or pitched downward about the x-axis toward the roadway by a camera pitch angle, θ, and the camera direction may not be aligned with the longitudinal and horizontal directions. Thus, using information captured by the camera for AD functions of the vehicle, the location of objects in images captured by the camera 120 in the camera coordinate system must be mapped, or projected, from the camera coordinate system to the roadway coordinate system by a projection tensor, T_{c2r}. Such a projection can be performed using algorithms based on a calibration of the camera position and orientation in the vehicle relative to the longitudinal and transverse direction of the vehicle. However, such a projection that is based on the camera position and orientation relative to the vehicle may nevertheless be susceptible to error due to variations of the roadway surface from a flat condition and variations of the vehicle orientation with respect to the roadway (e.g., due to changes in vehicle pitch about the x-axis and due to changes in vehicle role about the y-axis). Techniques to account for, and to correct for, such error are described herein.

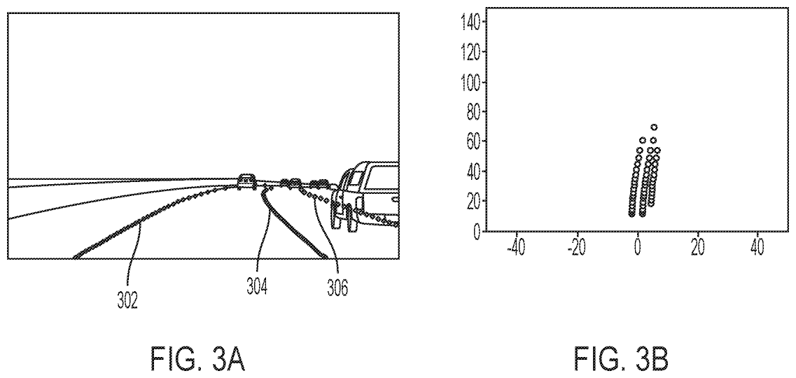

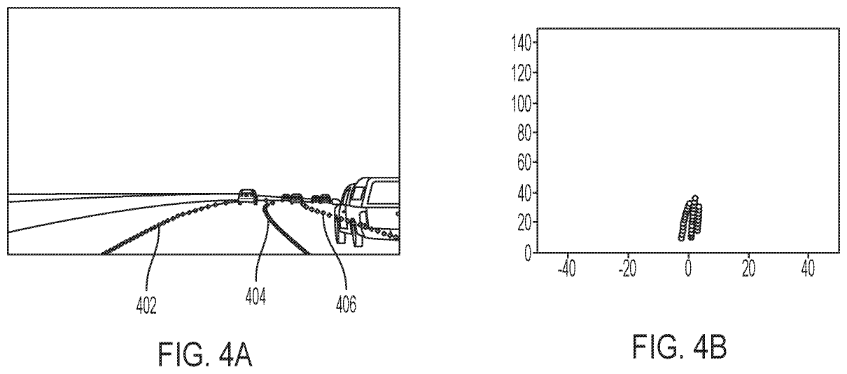

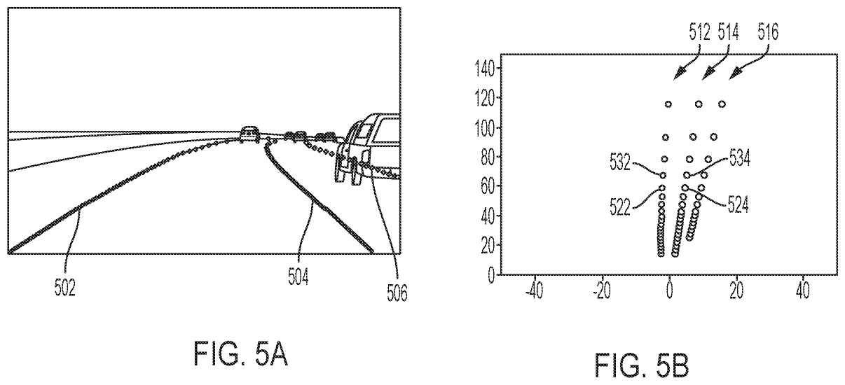

FIG. 3A, FIG. 4A, and FIG. 5A show example images of a scene captured by the camera 120 when the camera has different pitch angles with respect to the roadway. For example, in FIG. 3A, the pitch angle is 2.5°; and FIG. 4A, the pitch angle is 1.5°; and in FIG. 5A, the pitch angle is 3.5°. Overlaid on the images of the scene shown in FIG. 3A, FIG. 4A, and FIG. 5A are blue dots representing lane markings on the roadway on which the vehicle is traveling. For example, a first line of lane markings 302, a second line of lane markings 304, and a third line of lane markings 306 define a first lane between the first markings 302 and the second markings 304 and a second lane between the second markings 304 and the third markings 306. Similarly, lane markings 402, 404, 406 in FIG. 4A define a first lane and a second lane in the image of FIG. 4A, and lane markings 502, 504, 506 in FIG. 5A define a first lane and a second lane in the image of FIG. 5A.

The different pitch angles in FIG. 3A, FIG. 4A, and FIG. 5A can be due to a variety of factors. For example, the pitch angle of the camera 120, when installed in the vehicle, can have some variation from a designed pitch angle. In another example, the pitch angle of the camera 120 can depend on the load distribution within the vehicle—e.g., relatively more weight in the rear of the vehicle may result in a lower pitch angle, and relatively more weight in the front of the vehicle may result in a higher pitch angle. In another example, the pitch angle of the camera 120 can depend on an acceleration or deceleration of the vehicle, which causes the pitch of the vehicle with respect to the roadway to change. In another example, the pitch can depend on vibrations of the camera position and orientation due to irregular terrain, motor vibration, etc. In another example, a slope of the roadway that varies in the field of view of the camera may cause an apparent variation in pitch of the vehicle with respect to the roadway seen in the field of view, as determined by the objects in the images of FIG. 3A, FIG. 4A, and FIG. 5A.

FIG. 3B, FIG. 4B, and FIG. 5B show example projections, respectively, of the lane markings of FIG. 3A, FIG. 4A, and FIG. 5A to a roadway coordinate system having an origin on the roadway at a location between the front wheels of the vehicle. In FIG. 3B, FIG. 4B, and FIG. 5B, the distance of a lane marking in a longitudinal direction along the direction of the roadway is plotted on the Y-axis, and the distance of a lane marking from the origin in a transverse direction on the roadway is plotted on the X-axis. As can be seen from the projection of the lane markings to the roadway coordinate systems and FIG. 3B, FIG. 4B, and FIG. 5B, the pitch angle of the camera 120 affects the location of the projected lane markings in the roadway coordinate system. For example, with a pitch angle of 1.5°, the projected lane markings shown in FIG. 4B appear to converge with increasing distance away from the vehicle, and with a pitch angle of 3.5°, the projected lane markings shown in FIG. 5B appear to diverge with increasing distance away from the vehicle. Thus, the projected lane markings shown in FIG. 4B show the transverse width of the lanes decreasing with increasing distance from the vehicle along the roadway, and the projected lane markings shown in FIG. 5B show the transverse width of the lanes increasing with increasing distance from the vehicle along the roadway.

However, it may be assumed that the width of the lanes does not actually increase or decrease, but rather remains constant, as a function of distance from the vehicle. Therefore, based on this assumption, the projected locations of lane markings shown in FIG. 3B, FIG. 4B, and FIG. 5B can be corrected, normalized, or rescaled to a lane width at a predetermined distance away from the vehicle, so that the projected lane markings provide an accurate representation of that lane positions for use in related AD functions. Thus, the projected widths of the lanes can be corrected for a variable pitch of the camera without determining a pitch of the camera (e.g., though accelerometer or gyro sensor measurements) but rather by using the abundant visual data received from the camera.

In some implementations, the projected lane markings can be re-normalized by defining a cost function that measures a variance of the projected lane width over a range of distances from the vehicle and then adjusting the locations of the projected lane markings over the range of distances, such that the cost function is minimized. For example, in a first step, the coordinates of each line 512, 514, 516 of projected lane markings in FIG. 5B, which are derived from the coordinates of each line 502, 504, 506 of observed lane markings in FIG. 5A, can be fitted to a polynomial curve, so that the impact of any outlier points in the line can be reduced. Then, in a second step, using the fitted values of the coordinates of the projected lane markings for adjacent lines of projected markings, the width(s) of the lane(s), as defined by the transverse distance between points from adjacent lines of lane markings at a similar longitudinal distances from the vehicle can be determined. For example, referring to FIG. 5B, a width of the left lane (the travel lane of the vehicle) at a distance of about 60 meters from the vehicle can be determined from the difference between the lateral (i.e., X-axis) coordinates of points 522 and 524, and a width of the left lane at a distance of about 70 meters from the vehicle can be determined from the difference between the lateral coordinates of points 532 and 534. Then, using the determined width for a lane over a predetermined range of distances (e.g., from about 10 m to 80 m in front of the vehicle), a cost function can be defined based on the plurality of width measurements over the range of distances.

Ratios between determined widths of the lane at successive longitudinal distances can be determined, and a cost function can be defined based on a sum of the determined ratios over the range of distances. Then, the width at the different fixed longitudinal distances away from the vehicle can be rescaled, so that a variation of the widths, as defined by the ratios of successive width measurements at successive longitudinal distances for which the widths are measured, over the ranges of distances is minimized.

For example, a divergence or convergence of the lane widths can be modeled as function of distance from the vehicle, and one or more parameters that determine the amount of divergence/convergence of the lane width can be used as a variable to minimize the cost function. Such calculations can be performed very fast (e.g., in about two milliseconds or less), so that the projected lane widths and locations can be determined in real time and can reduce variation in the values due to vibrations of the camera position. The rescaled lane widths and coordinates of lane markings in the coordinate system of the roadway, which are associated with the rescaled lane widths, can be stored in a memory for use in an AD system, for example, to perform AD functions for the vehicle based on the rescaled lane widths and coordinates of lane markings in the coordinate system of the roadway, which are associated with the rescaled lane widths.

Variations of a lane width determined from the projected lane markings in the coordinate system of the roadway can be due to variations of camera pitch angle compared to a predetermined, or calibrated, value of the camera angle pitch, as discussed above with reference to FIGS. 3A, 3B, 4A, 4B, 5A, 5B. However, variations of a lane width determined from the projected lane markings in the coordinate system of the roadway also can be due to variations of camera roll angle about the y-direction in FIG. 2, compared to a predetermined, or calibrated, value of the camera roll angle. Such variations can be corrected and rescaled in the same manner as lane width variations due to camera angle pitch.

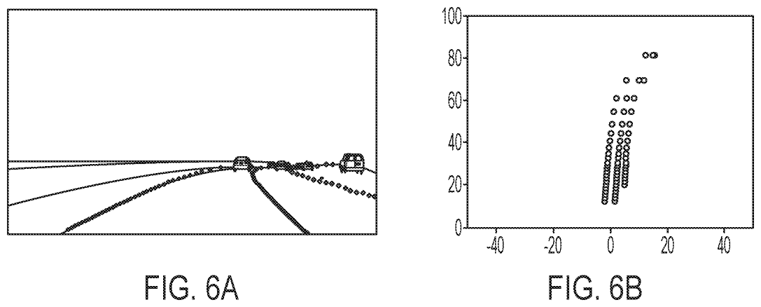

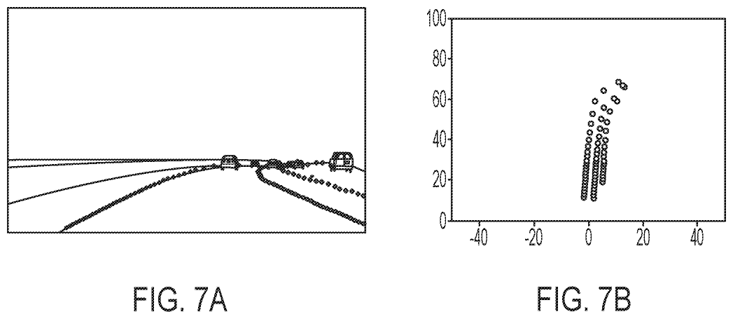

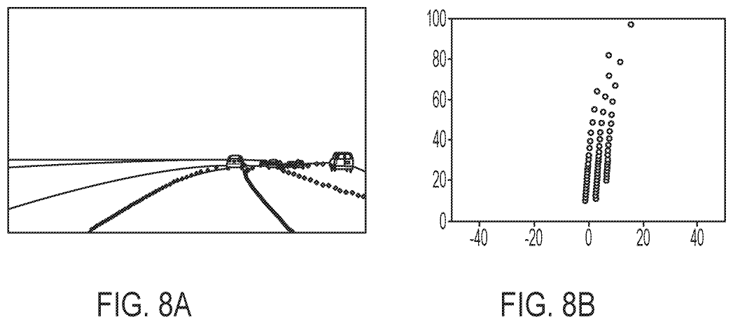

This is illustrated in FIGS. 7A and 7B, where the camera roll angle is 1.0 degrees and the left lane appears wider than the right lane far from the vehicle in projected lane markings of FIG. 6B, and in FIGS. 6A and 6B, where the camera roll angle is 0.0 degrees and the left lane is still wider than the right lane far from the vehicle in projected lane markings of FIG. 7B, although the difference between the widths of the left and right lanes is less in FIG. 6B than in FIG. 7B. In FIGS. 8A and 8B, where the camera roll angle is-2.0 degrees, the lane widths appear similar over a wide range of distances. The lane widths can be corrected in a manner similar to that described above with respect to FIGS. 3A, 3B, 4A, 4B, 5A, 5B.

For example, as described above, the projected lane markings can be re-normalized by defining a cost function that measures a variance of the projected lane width over a range of distances from the vehicle and then adjusting the locations of the projected lane markings over the range of distances, such that the cost function is minimized.

For example, in a first step, the coordinates of the lines of projected lane markings in FIGS. 6B, 7B, and 8B can be fitted to a polynomial curve, so that the impact of any outlier points in the line can be reduced. Then, using the coordinates of the projected lane markings for adjacent lines of projected markings, the width(s) of the lane(s), as defined by the transverse distance between points from adjacent lines of lane markings at a similar longitudinal distances from the vehicle can be determined. Then, using the determined width for a lane over a predetermined range of distances (e.g., from about 10 m to 80 m in front of the vehicle), a cost function can be defined based on the plurality of width measurements over the range of distances.

For example, ratios between determined widths of the lane at successive longitudinal distances can be determined, and a cost function can be defined as the sum of the ratios over the range of distances. Then, the width at the different longitudinal distances away from the vehicle can be rescaled, so that the variation of the widths, as defined by the ratios of successive width measurements, over the ranges of distances is minimized. The rescaling can be accomplished by a number of different fitting algorithms. For example, a divergence/convergence of the lane widths can be modeled as function of distance from the vehicle, and one or more parameters that determine the amount of divergence/convergence of the lane width can be used as a variable to minimize the cost function. Such calculations can be performed very fast (e.g., in about two milliseconds or less), so that the projected lane widths and locations can be determined in real time and can reduce variation in the values due to vibrations of the camera position.

Moreover, the projected lane width values can be corrected by a multi-parameter algorithm that accounts for lane width variations due to both pitch and roll angle variations.

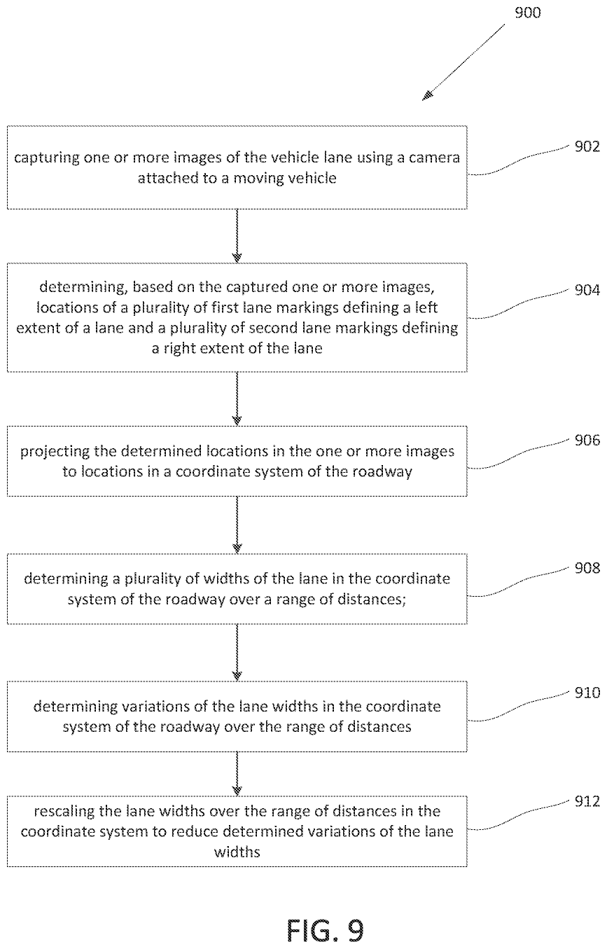

FIG. 9 is a flowchart of an example process 900 for determining a width of a vehicle lane on a roadway from imaged lane markings. The process 900 includes capturing one or more images of the vehicle lane using a camera attached to a moving vehicle (902) and determining, based on the captured one or more images, locations of a plurality of first lane markings defining a left extent of a lane and a plurality of second lane markings defining a right extent of the lane (904). The determined locations in the one or more images are projected onto locations in a coordinate system of the roadway (906), and a plurality of widths of the lane in the coordinate system of the roadway are determined over a range of distances (908). Variations of the lane widths in the coordinate system of the roadway are determined over the range of distances (910), and the lane widths are rescaled over the range of distances in the coordinate system to reduce determined variations of the lane widths (912).

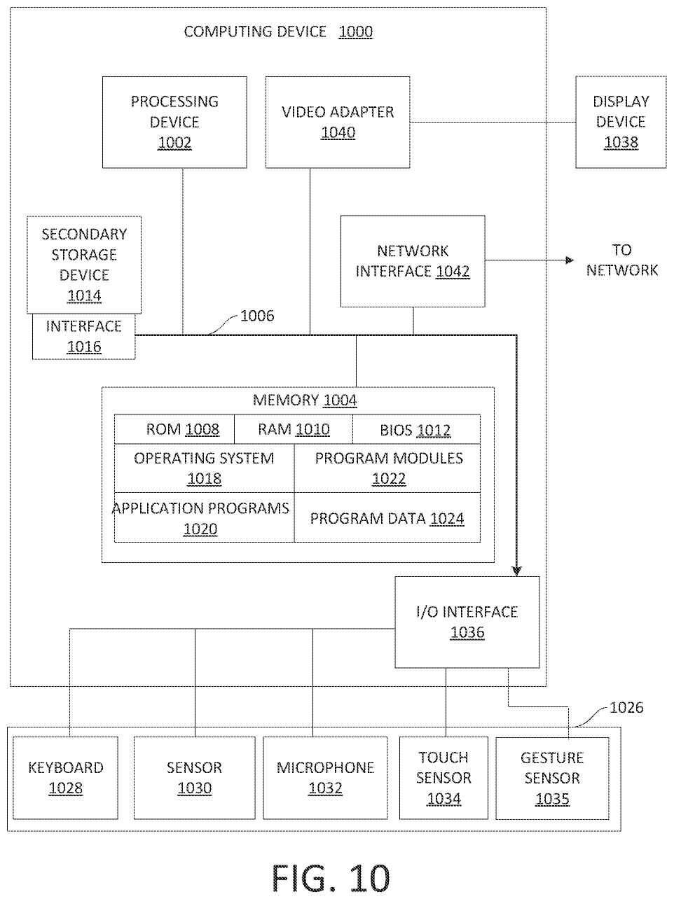

FIG. 10 illustrates an example architecture of a computing device 1000 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 10 can be used to execute the operating system, application programs, and/or software modules (including the software engines) described herein.

The computing device 1000 includes, in some embodiments, at least one processing device 1002 (e.g., a processor), such as a central processing unit (CPU). A variety of processing devices are available from a variety of manufacturers, for example, Intel or Advanced Micro Devices. In this example, the computing device 1000 also includes a system memory 1004, and a system bus 1006 that couples various system components including the system memory 1004 to the processing device 1002. The system bus 1006 is one of any number of types of bus structures that can be used, including, but not limited to, a memory bus, or memory controller; a peripheral bus; and a local bus using any of a variety of bus architectures.

The system memory 1004 includes read only memory 1008 and random access memory 1010. A basic input/output system 1012 containing the basic routines that act to transfer information within computing device 1000, such as during start up, can be stored in the read only memory 1008.

The computing device 1000 also includes a secondary storage device 1014 in some embodiments, such as a hard disk drive, for storing digital data. The secondary storage device 1014 is connected to the system bus 1006 by a secondary storage interface 1016. The secondary storage device 1014 and its associated computer readable media provide nonvolatile and non-transitory storage of computer readable instructions (including application programs and program modules), data structures, and other data for the computing device 1000.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 1014 and/or system memory 1004, including an operating system 1018, one or more application programs 1020, other program modules 1022 (such as the audio manager described herein), and program data 1024. The computing device 1000 can utilize any suitable operating system.

In some embodiments, a user provides inputs to the computing device 1000 through one or more input devices 1026. Examples of input devices 1026 include a keyboard 1028, sensor 1030, microphone 1032 (e.g., for voice and/or other audio input), touch sensor 1034 (such as a touchpad or touch sensitive display), and gesture sensor 1035 (e.g., for gestural input). In some implementations, the input device(s) 1026 provide detection based on presence, proximity, and/or motion. Other embodiments include other input devices 1026. The input devices can be connected to the processing device 1002 through an input/output interface 1036 that is coupled to the system bus 1006. These input devices 1026 can be connected by any number of input/output interfaces, such as a parallel port, serial port, game port, or a universal serial bus. Wireless communication between input devices 1026 and the input/output interface 1036 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 1038, such as a monitor, liquid crystal display device, light-emitting diode display device, projector, or touch sensitive display device, is also connected to the system bus 1006 via an interface, such as a video adapter 1040. In addition to the display device 1038, the computing device 1000 can include various other peripheral devices (not shown), such as loudspeakers.

The computing device 1000 can be connected to one or more networks through a network interface 1042. The network interface 1042 can provide for wired and/or wireless communication. In some implementations, the network interface 1042 can include one or more antennas for transmitting and/or receiving wireless signals. When used in a local area networking environment or a wide area networking environment (such as the Internet), the network interface 1042 can include an Ethernet interface. Other possible embodiments use other communication devices. For example, some embodiments of the computing device 1000 include a modem for communicating across the network.

The computing device 1000 can include at least some form of computer readable media. Computer readable media includes any available media that can be accessed by the computing device 1000. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1000.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 10 is also an example of programmable electronics, which may include one or more such computing devices, and when multiple computing devices are included, such computing devices can be coupled together with a suitable data communication network so as to collectively perform the various functions, methods, or operations disclosed herein.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter appearing in this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems.

While certain features of the described implementations have been illustrated as described herein, many modifications, substitutions, changes and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the invention.

1. A method of determining a width of a vehicle lane on a roadway from imaged lane markings, the method comprising:
capturing one or more images of the vehicle lane using a camera attached to a moving vehicle;
determining, based on the captured one or more images, locations of a plurality of first lane markings defining a left extent of a lane and a plurality of second lane markings defining a right extent of the lane;
projecting the determined locations in the one or more images to locations in a coordinate system of the roadway;
determining a plurality of widths of the lane in the coordinate system of the roadway over a range of distances;
determining variations of the lane widths in the coordinate system of the roadway over the range of distances; and
rescaling the lane widths over the range of distances in the coordinate system to reduce determined variations of the lane widths.

2. The method of claim 1, wherein variations of the lane widths are caused by one or more camera pitch angles that are different from a predetermined pitch angle and/or by one or more camera roll angles that are different from a predetermined roll angle.

3. The method of claim 1, further comprising:
storing the rescaled lane widths and coordinates of lane markings in the coordinate system of the roadway, which are associated with the rescaled lane widths, in a memory.

4. The method of claim 1, wherein rescaling the lane widths to reduce a sum of the variations includes minimizing a cost function associated with a variation of the lane widths over the range of distances and wherein minimizing the cost function includes modeling a divergence/convergence of the lane width as a function of distance from the vehicle and determining one more parameters used to rescale the lane widths over the range of distances, such that the parameters minimize the cost function.

5. The method of claim 1, further comprising:
for a plurality of fixed distances from the vehicle, determining ratios of successive determined lane widths;
determining a sum of the determined ratios; and
rescaling the lane widths over the range of distances in the coordinate system to reduce determined the determined sum.

6. The method of claim 1, further comprising:
fitting the determined locations of a plurality of first lane markings defining a left extent of a lane and a plurality of second lane markings defining a right extent of the lane to a polynomial curve; and
determining the locations of the first and second lane markings based on the fitted curve.

7. The method of claim 1, further comprising:
determining the lane widths for the range of distances based on transverse distances between locations of the first and second lane markings at similar distances from the vehicle.

8. A vehicle comprising:
a camera configured for capturing one or more images of a vehicle lane of a roadway while the vehicle is moving on the roadway;
one or more processors configured for executing machine-readable instructions, stored on a memory, to cause the one or more processors to:
determine, based on the captured one or more images, locations of a plurality of first lane markings defining a left extent of the vehicle lane and a plurality of second lane markings defining a right extent of the vehicle lane;
project the determined locations in the one or more images to locations in a coordinate system of the roadway;
determine a plurality of widths of the lane in the coordinate system of the roadway over a range of distances;
determine variations of the lane widths in the coordinate system of the roadway over the range of distances; and
rescale the lane widths over the range of distances in the coordinate system to reduce determined variations of the lane widths.

9. The vehicle of claim 8, wherein variations of the lane widths are caused by one or more pitch angles of the camera that are different from a predetermined pitch angle and/or by one or more roll angles of the camera that are different from a predetermined roll angle.

10. The vehicle of claim 8, further comprising:
a memory configured for storing the rescaled lane widths and coordinates of lane markings in the coordinate system of the roadway, which are associated with the rescaled lane widths.

11. The vehicle of claim 8, wherein rescaling the lane widths to reduce a sum of the variations includes minimizing a cost function associated with a variation of the lane widths over the range of distances and wherein minimizing the cost function includes modeling a divergence/convergence of the lane width as a function of distance from the vehicle and determining one more parameters used to rescale the lane widths over the range of distances, such that the parameters minimize the cost function.

12. The vehicle of claim 8, wherein the one or more processors are further configured for executing machine-readable instructions to cause the one or more processors to:
for a plurality of fixed distances from the vehicle, determine ratios of successive determined lane widths;
determine a sum of the determined ratios; and
rescale the lane widths over the range of distances in the coordinate system to reduce determined the determined sum.

13. The vehicle of claim 8, wherein the one or more processors are further configured for executing machine-readable instructions to cause the one or more processors to:
fit the determined locations of a plurality of first lane markings defining a left extent of a lane and a plurality of second lane markings defining a right extent of the lane to a polynomial curve; and
determine the locations of the first and second lane markings based on the fitted curve.

14. The vehicle of claim 13, wherein the one or more processors are further configured for executing machine-readable instructions to cause the one or more processors to:
determine the lane widths for the range of distances based on transverse distances between locations of the first and second lane markings at similar distances from the vehicle.
